(19) United States
(12) Patent Application Publication
(10) Pub. No.: US 2021/0233091 A1
(43) Pub. Date: Jul. 29, 2021

(54) SYSTEM AND METHOD FOR FACILITATING A RECORD OF INFORMATION OF AN ORGANISM

(71) Applicant: QUANTUMCIEL PTE. LTD., Singapore (SG)

(72) Inventor: Kang Wei WOO, Singapore (SG)

(73) Assignee: QUANTUMCIEL PTE. LTD., Singapore (SG)

(21) Appl. No.: 17/051,066

(22) PCT Filed: Apr. 26, 2019
(86) PCT No.: PCT/SG2019/050231

§ 371 Date: Oct. 27, 2020

(30) Foreign Application Priority Data
Apr. 27, 2018 (SG) 10201803558Q

(51) Int. Cl. G06Q 30/00; G06F 16/27; G06F 21/60; G06Q 20/36; H04L 9/30; G06Q 50/02; G06K 19/06

(52) U.S. Cl. CPC G06Q 30/018; G06F 16/27; G06F 21/602; G06Q 20/36; G06Q 2220/00; G06Q 50/02; G06K 19/06028; G06K 19/06037; H04L 9/30

(57) ABSTRACT

The present invention relates to a system and method for facilitating a record of information of an organism. The system may comprise a distributed ledger storing the information associated with an identifier of the organism; an input module operable to receive an input of the identifier attached to the organism; and a processor operable to analyse the identifier and display at least a part of the information associated with the organism, wherein the processor is further operable to generate additional information upon occurrence of an event for the organism, and record the additional information in the distributed ledger.

### FIELD OF INVENTION

The present invention relates to a system and method for facilitating a record of information of an organism.

### BACKGROUND ART

The following discussion of the background to the invention is intended to facilitate an understanding of the present invention only. It may be appreciated that the discussion is not an acknowledgement or admission that any of the material referred to was published, known or part of the common general knowledge of the person skilled in the art in any jurisdiction as at the priority date of the invention.

It is known that food safety and quality are important considerations along a food production chain. If along a food production chain contamination and/or unauthorized modification are introduced, food quality and food safety can be compromised, leading to sickness and/or fatalities.

Food contamination may be caused at a food source, for example seas, oceans or rivers by environmental pollution, climate change and/or natural disaster. In particular, with the industrial developments, pollutants have been produced and thereby caused serious environmental pollution such as soil and water pollution.

Another way food contamination can be introduced is through illegal practices such as an unregulated adulteration during farming, in which farmers may add something to agricultural, marine and/or livestock produce to make its external quality better with low costs and efforts.

At food preparation stage, food safety problems may occur due to improper preparation of food. For example, some restaurants may cook the product that had passed the expiration date or had been kept at room temperature too long, and serve the same to the consumers.

While various solutions have been introduced at different stage along the food production chain to mitigate the problems associated with food safety and contamination, there is at present no comprehensive solution which can ensure food safety and quality along every stage of food preparation.

In light of the above, there exists a need to provide a solution that meets the mentioned needs at least in part.

### SUMMARY OF THE INVENTION

The present invention seeks to provide a system and method that addresses the aforementioned need at least in part.

Throughout the specification, unless the context requires otherwise, the word “comprise” or variations such as “comprises” or “comprising”, will be understood to imply the inclusion of a stated integer or group of integers but not the exclusion of any other integer or group of integers.

Furthermore, throughout the specification, unless the context requires otherwise, the word “include” or variations such as “includes” or “including”, will be understood to imply the inclusion of a stated integer or group of integers but not the exclusion of any other integer or group of integers.

The invention seeks to provide a record system which traces agricultural, marine and/or livestock produce (hereinafter referred to as “organism”) from a place of origin of the origin to a ‘food’ state ready for consumption (pre-cooking or cooked state) by a consumer. The record system is tamper proof and provides a proof of authenticity of the organism which could be in the form of an identifier tagged or embossed on the organism.

Throughout the description, food may be referred to as agricultural, marine and/or livestock produce suitable for consumption by a consumer, whether in the live, raw form or otherwise.

The technical solution is provided in the form of a system and method for facilitating a record of information of the organism. In particular, the system comprises a distributed ledger of a plurality of nodes. The information of the organism may be stored in the distributed ledger. Once an event, for example environmental changes and/or transaction, occurs, information associated with the event may be recorded in the distributed ledger. A plurality of computing devices may be implemented as the plurality of nodes on the distributed ledger, so the information stored in the distributed ledger is unable to be forged by counterfeits and/or edited by unauthorized person. Therefore, the consumer is able to check trustworthy information associated with the organism before buying or consuming the organism.

In accordance with an aspect of the present invention, there is a system for facilitating a record of information of an organism comprising: a distributed ledger storing the information associated with an identifier of the organism; an input module operable to receive an input of the identifier attached to the organism; and a processor operable to analyse the input and display at least a part of the information associated with the organism, wherein the processor is further operable to generate additional information upon occurrence of an event for the organism, and record the additional information in the distributed ledger.

Preferably, a plurality of computing devices are implemented as a plurality of nodes on the distributed ledger, and the input module and the processor are implemented in at least one of the plurality of computing devices.

Preferably, the identifier contains at least one of encoded data and encrypted data.

Preferably, once the input of the identifier is received, the processor is operable to decode the identifier containing the encoded data without connecting to a communication network, and display the decoded data.

Preferably, the processor is operable to connect to the communication network to decrypt the encrypted data.

Preferably, the distributed ledger comprises a plurality of blocks, and each block of the plurality of blocks stores information associated with each identifier allocated to each organism.

Preferably, the processor is operable to record the additional information in a set of blocks among the plurality of blocks, and each block of the set of blocks stores the information associated with the identifier of the organism.

Preferably, the plurality of computing devices include at least one electronic device operable to monitor the event for the organism and generate the additional information relating to the event.

Preferably, the event comprises at least one of the following: transaction and environmental factor.

Preferably, the electronic device comprises at least one of the following: a sensor, an actuator, a monitor and a camera.

Preferably, the electronic device is deployed to monitor the environmental factor of an area where the organism is farmed.

Preferably, the identifier is in a form of at least one of the following: a QR code, barcode, data matrix and maxicode.

Preferably, the identifier is marked on a body of the organism or is attached on the organism using a tag.

Preferably, the identifier further contains a public key of a digital wallet associated with the identifier of the organism, and the processor is operable to record the additional information in the distributed ledger using the digital wallet.

Preferably, the processor is operable to verify an ownership of the organism using a private key stored in the digital wallet.

Preferably, once the organism is consumed, the processor is operable to close the digital wallet.

Preferably, the information comprises at least one of genomic information, environmental information and transaction status information.

In accordance with another aspect of the present invention, there is a method for facilitating a record of information of an organism comprising: storing, on a distributed ledger, the information associated with an identifier of the organism; receiving, by an input module, an input of the identifier attached to the organism; analysing, by a processor, the identifier; displaying, by the processor, at least a part of the information associated with the organism; generating, by the processor, additional information upon occurrence of an event for the organism; and recording, by the processor, the additional information in the distributed ledger.

Preferably, a plurality of computing devices are implemented as a plurality of nodes on the distributed ledger, and the input module and the processor are integrated in at least one of the plurality of computing devices.

Preferably, the identifier contains at least one of encoded data and encrypted data.

Preferably, once the input of the identifier is received, the processor is operable to decode the identifier containing the encoded data without connecting to a communication network, and display the decoded data.

Preferably, the processor is operable to connect to the communication network to decrypt the encrypted data.

Preferably, the distributed ledger comprises a plurality of blocks, and each block of the plurality of blocks stores information associated with each identifier allocated to each organism.

Preferably, the processor is operable to record the additional information in a set of blocks among the plurality of blocks, and each block of the set of blocks stores the information associated with the identifier of the organism.

Preferably, the plurality of computing devices include at least one electronic device operable to monitor the event for the organism and generate the additional information relating to the event.

Preferably, the event comprises at least one of the following: transaction and environmental factor.

Preferably, the electronic device comprises at least one of the following: a sensor, an actuator, a monitor and a camera.

Preferably, the electronic device is deployed to monitor the environmental factor of an area where the organism is farmed.

Preferably, the identifier is in a form of at least one of the following: a QR code, barcode, data matrix and maxicode.

Preferably, the identifier is marked on a body of the organism or is attached on the organism using a tag.

Preferably, the identifier further contains a public key of a digital wallet associated with the identifier of the organism, and the processor is operable to record the additional information in the distributed ledger using the digital wallet.

Preferably, the processor is operable to verify an ownership of the organism using a private key stored in the digital wallet.

Preferably, once the organism is consumed, the processor is operable to close the digital wallet.

Preferably, the information comprises at least one of genomic information, environmental information and transaction status information.

Other aspects of the invention will become apparent to those of ordinary skilled in the art upon review of the following description of specific embodiments of the invention in conjunction with the accompanying drawings.

### BRIEF DESCRIPTION OF THE DRAWINGS

The present invention will now be described, by way of example only, with reference to the accompanying drawings, in which:

FIG. 1 is a block diagram of an embodiment of the present invention.

FIG. 2 is another block diagram of an embodiment of the present invention.

FIG. 3 is a flowchart of an embodiment of the present invention.

FIG. 4 illustrates various embodiments showing an identifier attached to an organism.

FIG. 5 illustrates embodiments of DNA barcode for a record.

FIG. 6 illustrates an embodiment of a monitoring of the environment.

Other arrangements of the invention are possible and, consequently, the accompanying drawings are not to be understood as superseding the generality of the preceding description of the invention.

### DESCRIPTION OF EMBODIMENTS OF THE INVENTION

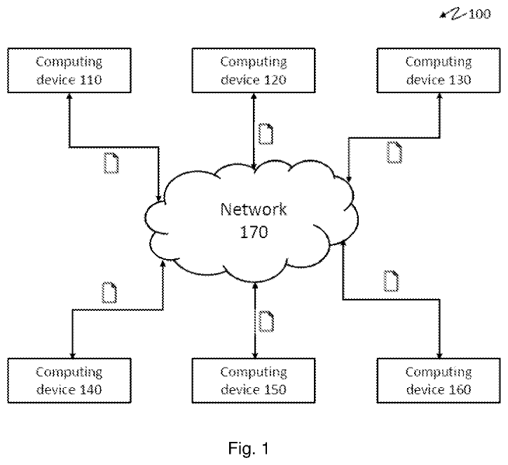

FIG. 1 is a block diagram of a system 100 in accordance with an embodiment of the present invention.

The system 100 may provide at least one distributed ledger across a plurality of computing devices 110, 120, 130, 140, 150 and 160. The computing devices 110, 120, 130, 140, 150 and 160 may be implemented as a plurality of nodes on the distributed ledger. The distributed ledger may include a blockchain.

Each entity of the computing devices 110, 120, 130, 140, 150 and 160 may include, but not be limited to, farmer, exporter, importer, restaurant outlet, retail outlet, consumer and diner. The computing devices 110, 120, 130, 140, 150 and 160 may include, but not be limited to, smartphone, desktop computer, laptop, tablet computer and wearable devices, in particular intelligent wearable devices such as smart watch, smart glasses or mobile virtual reality headset.

The computing devices 110, 120, 130, 140, 150 and 160 may maintain and/or update the distributed ledger. The distributed ledger may be updated periodically or from time to time with modifications to the ledger. The modifications, for example, may include, but not be limited to an insertion or an update of a ledger entry.

Under the system 100, once an issue occurs with the distributed ledger, the issue can be resolved based on an issue resolution logic. The issue may include, but not be limited to, hash collision and corrupted ledger entries. The issue resolution logic may be distributed among the computing devices 110, 120, 130, 140, 150 and 160.

The computing devices 110, 120, 130, 140, 150 and 160 may be utilised as a decentralized processor as well as database. Therefore, each computing device 110, 120, 130, 140, 150 and 160 may be implemented as a plurality of nodes for storing a copy of the ledger. The ledger may be collaboratively maintained by anonymous peers on a network 170. In another embodiment, the ledger may be only maintained and stored on a set of trusted nodes, for example computing devices of authorized users.

In some embodiments, the ledger may be used for a record of information of an agricultural, marine and/or livestock produce (hereinafter referred to as “organism”). The information of the organism may include at least one of genomic information, environmental information and transaction status information. As described above, the computing devices 110, 120, 130, 140, 150 and 160 may be utilised as a decentralized processor as well as database. Each computing devices 110, 120, 130, 140, 150 and 160 may be referred to as “nodes” of the system 100. The number of nodes may vary or be fixed. The ledger copies which are maintained and stored on each node enable cross-validation with one another. For example, when a conflict event occurs between ledger entries, the computing devices 110, 120, 130, 140, 150 and 160 are operable to conduct the cross-validation with one another. Hence, the information of the organism recorded in the distributed ledger may be secured even though the conflict event occurs.

In addition, the ledger may be used to track the information of the organism. The ledger may have entries linked to one another using cryptographic information of the organism. Further, the ledger may be ordered and time stamped, to prevent from double transfers and/or unauthorized tampering or modification of the ledger entries.

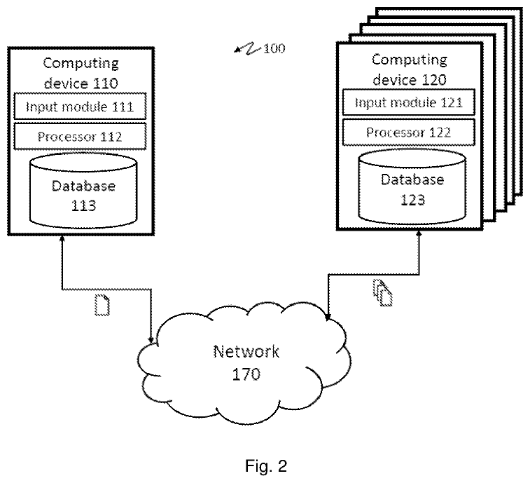

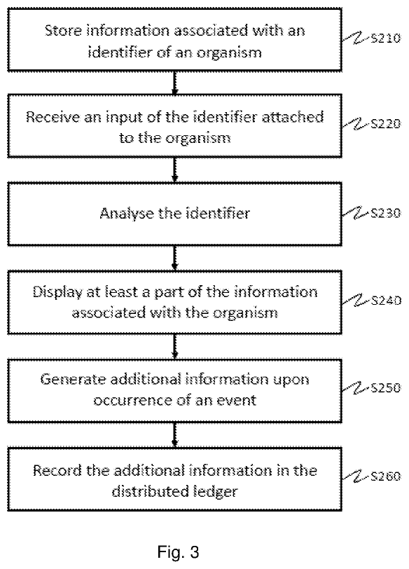

FIG. 2 is another block diagram and FIG. 3 is a flowchart of an embodiment of the present invention.

The computing devices 110, 120, 130, 140, 150 and 160 may comprise an input module, a processor and a database. For example, a computing device 110 may generate and manage the information of the organism using an input module 111, a processor 112 and a database 113. The input module 111 may include, but not be limited to, an image scanning device, a manual input device and a voice input device.

The information of the organism is maintained using blocks organised in blockchains stored in the database 113 of the computing device 110. Although not shown, the information of the organism is also maintained using blocks organised in blockchains stored in databases of the other computing devices 120, 130, 140, 150 and 160.

An initial owner of the organism, for example a farmer, may register the organism as well as his/her ownership for the organism, and create information associated with the organism. The organism may be assigned an identifier. It may be appreciated that each individual organism may be assigned a unique identifier. The identifier may be attached to the organism. For example, the identifier may be marked or embossed on a body of the organism, or attached on the organism using at least one tag.

After registering the organism, an initial block records the information, for example registration information, ownership information and permission information, of the organism. The subsequent owners such as exporter, importer, restaurant outlet, retail outlet, consumer and diner may also register their ownership for the organism and create the information associated with the organism.

The permission information may be used to authorize at least one computing devices 110, 120, 130, 140, 150 and 160 to create a new block. The authorized computing device may include a computing device belonging to the current owner of the organism. The authorized computing device can be used to create the new block or be added as a new block using the processor. The new block is linked to a set of blocks which relate to the organism. For example, a computing device of an importer can create a new block for insertion into the set of blocks of the organism to record the import details of the organism.

As described above, the information associated with the identifier of the organism may be stored in the set of blocks of the distributed ledger (S210).

For example, the computing device 110 may be authorized to create the new block using the processor 112. The input module 111 of the computing device 110 may be used to receive an input of an identifier attached to the organism (S220). The input module 111 may transmit a raw data in relation to the input of the identifier to the processor 112.

In some embodiments, the input module 111 may be an image capturing device that is used to scan the organism and find the identifier of the organism. The image capturing device may include, but not be limited to, a sensor, camera and scanner such as QR code scanner or barcode scanner. In another example, the input module 111 may be a manual input device that is used to receive a manual input for the identifier. The manual input device may include, but not be limited to a keypad, keyboard, touchpad, touch screen, and pointing device. In another example, the input module 111 may include a voice input device, for example a microphone, that is used to receive an audio input for the identifier.

The identifier may be in the form of at least one of the following: a QR code, barcode, data matrix and maxicode. In another embodiments, the identifier may be in the form of pin numbers, alphanumeric code or security pattern.

The processor 112 may analyse the identifier (S230). In some embodiments, the processor 112 may receive the raw data from the input module 111 and process the raw data. For example, the processor 112 may interpret the raw data to obtain an image of the identifier. The processor 112 may then detect and/or verify that the identifier is associated with the organism. It is to be appreciated that the processor 112 may utilise a database 113, external database and/or the distributed ledger to detect and/or verify the identifier.

Thereafter, the processor 112 may extract and then display at least a part of the information associated with the organism (S240). In some embodiments, the identifier contains at least one of encoded data and encrypted data. Once the identifier is detected, the processor 112 is operable to decode the identifier containing the encoded data. It may be appreciated that the encoded data may be decoded by the processor 112 without connecting to a communication network, for example an Internet network. The processor 112 may then output the decoded data on a display (now shown) of the computing device 110. Although not shown, the decoded data may comprise at least a part of the information of the organism, for example genomic species and/or transaction history.

The processor 112 is further operable to decrypt the encrypted data contained in the identifier. If a user, for example an importer, requests for the decryption of the encrypted data, the processor 112 may connect to communication network to decrypt the encrypted data. Therefore, the processor 112 may render and/or output the properly decrypted data on the display. As described above, the identifier further contains the encrypted data, since any arbitrary sequence may be encoded and there is no basis to assure integrity or to counter against spoofing. To enforce any security issue, the identifier may be encrypted with the private key, for example encryption key. The identifier may be decrypted by the public key which is distributed with a digital wallet. The digital wallet may be a software running on an Operating System (OS) such as Android or iOS.

In some embodiments, the decrypted data may include the information, for example at least one of genomic information, environmental information and transaction status information of the organism. It may also be appreciated that the decrypted data may include a private key of a digital wallet associated with the identifier of the organism.

In some embodiments, the processor 112 may generate additional information upon occurrence of an event (S250), and then record the additional information in the distributed ledger (S260).

The processor 112 may monitor the occurrence of the event and generate the additional information relating to the event. The event may comprise at least one of transaction and environmental factor. The transaction event may comprise, not be limited to, a creation of a genetic profile, movement to a farm, transaction from a farmer to an exporter, transaction from the exporter to an importer, transaction from the importer to a restaurant outlet (or retail outlet), and transaction from the restaurant outlet to a consumer (or diner).

The generated information may include, not be limited to at least one of genomic information, environmental information and transaction status information of the organism. The generated information may further include time, location, buyer and/or seller information relating to the transaction.

In another embodiment, the plurality of computing devices 110, 120, 130, 140, 150 and 160 may include at least one electronic device operable to monitor the event, for example environmental event associated with the organism and generate the additional information relating to the event. The electronic device comprises at least one of the following: a sensor, an actuator, a monitor and a camera. It is to be appreciated that the actuator may include, but not be limited to, a laser-marker which marks an identifier, for example encrypted QR code, and a switcher gate which sorts the organism into different channels, for example based on size.

It may be appreciated that one or more cameras may be deployed and programmed to automatically monitor the organisms across the different processes, for example from hatchery to grow-out pond, from farm to logistical distribution, and from kitchen to table. It is to be appreciated that one or more cameras may be deployed and programmed to automatically monitor the environment of an area where the organism is farmed, for example a farm.

The electronic device may be programmed or configured as a node for the distributed ledger. In an embodiment, once the environmental event, for example natural disaster such as flood, typhoon or drought, occurs in an area where the organism is farmed, the electronic device may generate the information relating to the event. The electronic device may create a new block for insertion into the set of blocks of the organism to record the natural disaster details.

It is to be appreciated that the plurality of computing devices 110, 120, 130, 140, 150 and 160 may include at least one electronic device operable to monitor a certification, test or examination event associated with the organism and generate the additional information relating to the event. Each entity of the electronic device may include authorised institution or agency such as food inspection agency and certification agency. The electronic device may be programmed or configured as a node for the distributed ledger.

In an embodiment, once an organism obtains an organic certification, the electronic device of the certification agency may create a new block for insertion into the set of blocks of the organism to record the organic certification details. In another embodiment, once an organism gets a vaccination, for example a vaccination of animals against viral disease, the electronic device of the authorised food inspection agency may create a new block for insertion into the set of blocks of the organism to record the vaccination details.

It may be appreciated that the distributed ledger comprises a plurality of blocks. Each block within the plurality of blocks stores information associated with the unique identifier allocated to each organism. A set of blocks among the plurality of blocks stores the information associated with the identifier of the organism. Therefore, the processor 112 is operable to record the additional information in the set of blocks among the plurality of blocks.

The additional information as well as the information of the organism may be stored in the distributed ledger. Since the plurality of computing devices 110, 120, 130, 140, 150 and 160 are implemented as the plurality of nodes on the distributed ledger, the information stored in the distributed ledger is unable to be forged by counterfeits and/or edited by unauthorized person. Further, a fraudulent transaction may be easily exposed as there is a mismatch in the information, for example identity, transaction time and location, of the organism. Accordingly, the buyer or the consumer is able to check trustworthy information associated with the organism before buying or consuming the organism.

In some embodiments, a digital wallet associated with the identifier of the organism may be used. Each digital wallet may be associated with each individual organism. The digital wallet may generate a private key and derive a corresponding public key.

The public key may be a public address of the digital wallet.

In some embodiments, the digital wallet may include a smart contract wallet on a server-side wallet associated with the organism. The processor 112 is operable to record the additional information in the distributed ledger using the digital wallet. Therefore, the relevant and auditable events, for example time, location, buyer and/or seller information of the transaction, associated with the organism may be also recorded in the digital wallet. The traceability audit is enabled by the blockchain itself. The digital wallet may further include a client-side wallet for the transaction. There may be a trade-off between on and off blockchain elements, also in the structure of the smart contract.

In some embodiments, once the organism is consumed, the processor 112 is operable to generate information relating to the consumption and record the generated information in the distributed ledger. The processor 112 is further operable to close the digital wallet. It is to be appreciated that even though the organism is consumed, all the information of the organism may still be kept in the distributed ledger, without deletion or removal. It is to be appreciated that, since the information relating to the consumption of the organism has been recorded in the distributed ledger, no more transaction of the organism may be possible and nobody can use the same identifier.

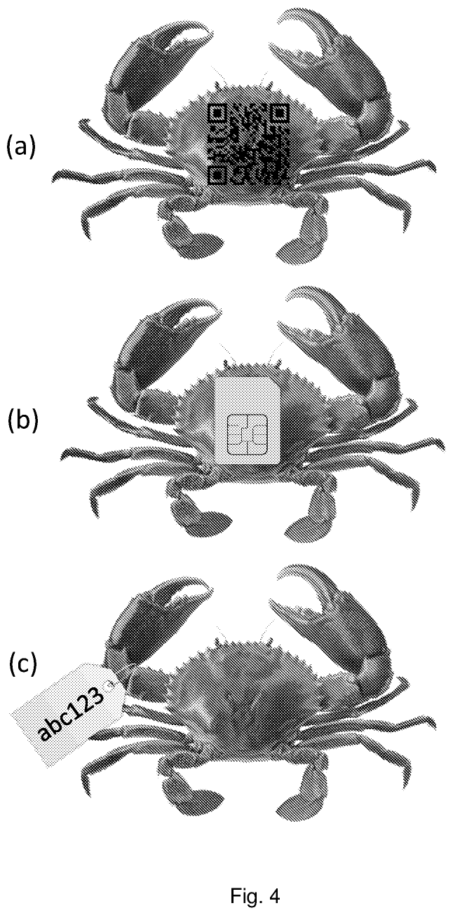

FIG. 4 illustrates various embodiments showing an identifier attached to an organism.

The identifier is in a form of at least one of the following: a QR code, barcode, data matrix and maxicode. In another embodiments, the identifier may include pin numbers, alphanumeric code or security pattern.

The identifier may be attached to the organism. As shown in FIG. 4(a), the identifier may be marked or embossed on a body of the organism. As shown in FIGS. 4(b) and 4(c), the identifier may be attached on the organism using a tag. The tag may include, but not be limited to, a paper tag, textile tag, elastic band tag, microchip and Radio-frequency identification (RFID) chip. In some embodiments, the tag may be implanted under the skin of the organism.

Although not shown, it may be appreciated that the identifier may be attached to the organism in a plurality of forms to avoid loss or damage. For example, the identifier may be marked on the body of the organism and concurrently be attached to the organism using at least one tag.

It is to be appreciated that the form of the identifier may be changed depending on the age of the organism or stage of farming/transaction. In an embodiment, the identifier may be attached by the tag, for example the elastic band, at an appropriate age of the organism. In the final stage before the organism leaves the farm, the identifier may be marked, for example laser-marked, on the body, for example on the carapace (i.e. upper hard shell) of a crab.

The laser-mark may be useful in terms of security control. The laser-mark may deter the forging of the counterfeits. The identifier, for example QR code with encrypted credentials (data), is resistant to unauthorized duplication. Since the identifier contains encrypted data and information is recorded in the distributed ledger, an unauthorized duplicated QR code may be immediately detectable by the system 100.

The buyer or the consumer is able to check trustworthy information associated with the organism before buying or consuming the organism. For example, a diner may scan the QR code before the crab is prepared for cooking (i.e. before the integrity of the crab is literally lost) to draw out the detailed information of the crab. After dining, the carapace itself may be given away as a keepsake for the diner.

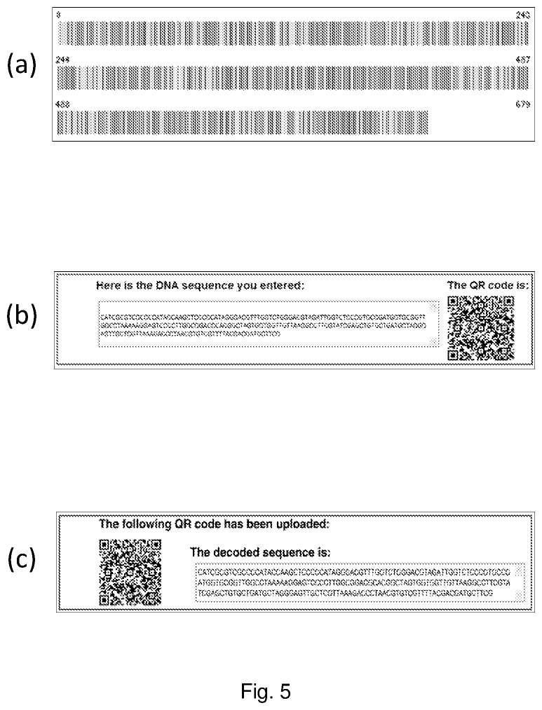

FIG. 5 illustrates embodiments of DNA barcode for a record.

The system 100 may manage an entire farming operations, for example crab farming operations. The system 100 may utilise a plurality of blockchains and an application. It is to be appreciated that the application may be a decentralized application (hereinafter referred to as “crab application”).

A genomic profiling approach may include a DNA barcode approach (hereinafter referred to as “first approach”) and a DNA fingerprint approach (hereinafter referred to as “second approach”). The first approach uses a cytochrome oxidase I (COI) gene in a mitochondria to differentiate different organism species, for example different animal species. FIG. 5(a) shows a color-coded DNA barcode using the mitochondrial COI gene in accordance with the first approach. The second approach uses DNA sequences at the micro-satellite sites which are variable even across members of the same species.

In some embodiments, the system 100 may conduct a random sampling of the batch of crabs to affirm the genetic identity through the first approach, and then augment the information with the unique public address of a digital wallet (hereinafter referred to as “crab wallet”) through the physical and indelible binding on the carapace of the crab, for example laser-marking. This initial binding is time-stamped and/or location-stamped and signed with the private key, for example signing key, of the crab application.

In another embodiment, the system 100 may apply the first approach on every crab. It may also be appreciated that the system 100 may apply the second approach on every crab. The system 100 may rest on the effective mitigation of costs associated with the extended representation of the genomic immutability over the lifecycle of the crab by cryptographic means.

In some embodiments, the encoded data uses the encoding in the QR code as an identifier of the crab. In this regard, the system 100 is able to transfer reasonably large amount of information in the QR code symbol. FIG. 5(b) shows a transformation from the DNA barcode to the QR code, and FIG. 5(c) shows a transformation from the QR code to the DNA barcode.

The QR code may further contain the encrypted data, since any arbitrary sequence may be encoded and there is no basis to assure integrity or to counter against spoofing. To enforce any security issue, the QR code may be encrypted with the private key, for example encryption key. The QR code may be decrypted by the public key which is distributed with the crab wallet. The crab wallet may be a software running on an Operating System (OS) such as Android or iOS. The decrypted data may be outputted on the computing device for display.

It may be appreciated that the information of the crab may be stored in the distributed ledger. Since the plurality of computing devices 110, 120, 130, 140, 150 and 160 are implemented as the plurality of nodes on the distributed ledger, a fraudulent transaction may be easily exposed as there is a mismatch in the information. An illegitimate clone of the QR code is unable to maintain some or all the integrity checks of the attributes of the crab and it shall fail the authentication during a cryptographic transaction. For example, the same crab is unable to complete the same transaction twice. The same crab is unable to transact out-of-time or out-of-location. It is to be appreciated that the legitimacy of the QR code derives from the signature with the private key, for example signing key, of the crab application.

There may be different users of the crab application, for example farmer, exporter, importer, restaurant outlet, retail outlet, consumer and diner. The crab wallet may be a software running on the computing device which allows the users to participate in the transactions with the plurality of blockchains depending on the permissions assigned to the users.

In some embodiments, the crab wallet may include a smart contract wallet on a server-side wallet associated with the crab. The digital wallet may further include a client-side wallet for the transaction. In the crab application, the server-side wallet may generate the private key for the crab, derive the corresponding public key which also may act as the public address of the crab wallet, and prepare the QR code for the laser-marking onto the carapace. The server-side wallet may be operated securely by the crab application server, since the crab is passive and incapable of computation. The server-side wallet for the crab may close at the point of consumption, and no further transaction may be possible. It is to be appreciated that public details from the previous transactions may remain available.

In the same crab application, a user with the client-side wallet may generate his/her own private key without divulging it to another user, derive the corresponding public key (public address of the crab wallet), and send the public address of the crab wallet to the crab application server for registration.

There are different smart contracts between different contracting parties in the system 100. The structure of the smart contract defines the rules of the contract (cast as a software program) which are cryptographically enforced and unable to be altered post-transaction.

As described above, the system 100 may utilise the plurality of blockchains, for example two blockchains. A first blockchain may be a public blockchain to conduct the transactions of the utility token, for example based on the ERC20 protocol, and a second blockchain may be a private blockchain to conduct all the other transactions not involving the utility token. There may be different sources, for example commercial invoices, logistic documents, provenance records and/or genomic studies, which utilise the private blockchain for the intended integrity of the system 100.

The system 100 may have a capability to observe both the genotype and phenotype due to the extensive surveillance at the farming stage. Therefore, the system 100 is able to select the strong traits for the breeding of the future generations of the crabs by means of comparative genomics infused with clinical inputs, for example time series of size, and weight. The details of the strong traits of the crab may be recorded on the private blockchain. Only authorized users such as researchers are able to have access in the conduct of the improvement program. The other general users such as consumer may have access to fewer details on the same private blockchain, in relation to the provenance of the crab.

It is to be appreciated that in balancing the bookkeeping on and off the blockchain, the system 100 may be an effective hybrid system where the genomic improvement is tracked for the outcome and the information is utilized in a feedback loop for the next round of improvement. The capability in the genomic science leads directly to the engineering capability to anticipate and regulate the supply of the produce in the ecosystem. In some embodiments, the system 100 provides an automated process to measure the growth parameters of the crab to constitute the carapace width-weight relation (CWR) in a time series. The system 100 is able to automate the laser-marking/marking recognition and the measurement acquisition by laser ranging and weight determination in a single pass process for the needed industrial efficiency. There may also be other measurements, for example related to crab meat density and quality. Subjective items such as taste tests may also be included in the program.

In this manner, the system 100 is able to identify the desirable physical traits in the strong phenotypes. The strong phenotypes may already be selected for mating without the genomic feedback. As a further step, the strong phenotypes are benchmarked against the “normal” phenotypes in a comparative genomics analysis where the coding sequences (CDS) are aligned to identify the specific point mutation(s) in the suspected gene(s) to confirm the causal relation.

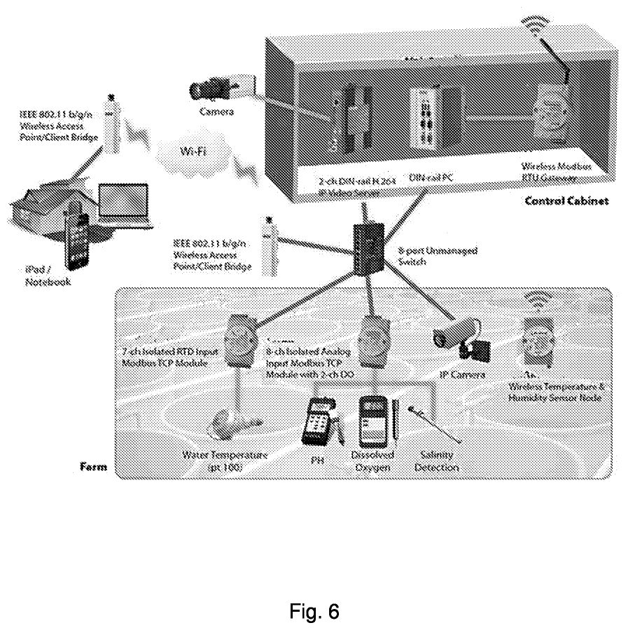

FIG. 6 illustrates an embodiment of a monitoring of the environment to mitigate environmental factors or contamination which can affect the quality of the one or more organism reared for food.

The system 100 may deploy an overlay of Internet of Things (loT) sensor to protect and monitor the environment of the farm to ensure the wellbeing of one or more organisms. The system 100 may implement early warning and isolation measures to mitigate the different types of threat. Further, the system 100 may deploy one or more cameras to monitor personnel access and movement in the environment of the farm. The system 100 may also deploy water quality monitors and other sensors. In another embodiment, the system 100 may deploy one or more autonomous drones to complete these tasks by means of periodic or non-periodic fly-by missions.

In some embodiments, when a pond is emptied of the batch of crabs after harvest, the system 100 may implement eco-friendly technologies to clean the pond for use with the next batch of crabs. The system 100 may also record this in the distributed ledger.

It may be appreciated that these monitors, sensors, cameras and/or drones may also be implemented as node(s) on the distributed ledger and interfaced to the distributed ledger (for example, blockchain).

It may be appreciated by the person skilled in the art that variations and combinations of features described above, not being alternatives or substitutes, may be combined to form yet further embodiments falling within the intended scope of the invention.

1. A system for facilitating a record of information of an organism comprising:
a distributed ledger storing the information associated with an identifier of the organism, wherein a plurality of computing devices are implemented as a plurality of nodes on the distributed ledger, and the input module and the processor are implemented in at least one of the plurality of computing devices;
an input module operable to receive an input of the identifier attached to the organism; and
a processor operable to analyse the identifier and display at least a part of the information associated with the organism,
wherein the processor is further operable to generate additional information upon occurrence of an event for the organism, and record the additional information in the distributed ledger, and wherein the information includes genomic information.

2. (canceled)

3. The system according to claim 1,
wherein the identifier contains encoded data; and
wherein once the input of the identifier is received, the processor is operable to decode the identifier containing the encoded data without connecting to a communication network and display the decoded data.

4. (canceled)

5. The system according to claim 1,
wherein the identifier contains encrypted data; and
wherein the processor is operable to connect to the communication network to decrypt the encrypted data.

6. The system according to claim 1,
wherein the distributed ledger comprises a plurality of blocks, and each block of the plurality of blocks stores information associated with the identifier allocated to the organism; and
wherein the processor is operable to record the additional information in a set of blocks among the plurality of blocks, and each block of the set of blocks stores the information associated with the identifier of the organism.

7. (canceled)

8. The system according to claim 1,
wherein the plurality of computing devices include at least one electronic device operable to monitor the event for the organism and generate the additional information relating to the event;
wherein the electronic device comprises at least one of the following: a sensor, an actuator, a monitor and a camera; and
wherein the electronic device is deployed to monitor the environmental factor of an area where the organism is farmed.

9. (canceled)

10. (canceled)

11. (canceled)

12. The system according to claim 1, wherein the identifier is in a form of at least one of the following: a QR code, barcode, data matrix and maxicode.

13. The system according to claim 12, wherein the identifier is marked on a body of the organism or is attached on the organism using a tag.

14. The system according to claim 12, wherein the identifier further contains a public key of a digital wallet associated with the identifier of the organism, and the processor is operable to record the additional information in the distributed ledger using the digital wallet.

15. The system according to claim 14, wherein the processor is operable to verify an ownership of the organism using a private key stored in the digital wallet.

16. The system according to claim 14, wherein once the organism is consumed, the processor is operable to close the digital wallet.

17. (canceled)

18. A method for facilitating a record of information of an organism comprising:
storing, on a distributed ledger, the information associated with an identifier of the organism, wherein a plurality of computing devices are implemented as a plurality of nodes on the distributed ledger, and the input module and the processor are integrated in at least one of the plurality of computing devices;
receiving, by an input module, an input of the identifier attached to the organism;
analysing, by a processor, the identifier;
displaying, by the processor, at least a part of the information associated with the organism;
generating, by the processor, additional information upon occurrence of an event for the organism; and
recording, by the processor, the additional information in the distributed ledger, wherein the information includes genomic information.

19. (canceled)

20. The method according to claim 18,
wherein the identifier contains encoded data; and
wherein once the input of the identifier is received, the processor is operable to decode the identifier containing the encoded data without connecting to a communication network and display the decoded data.

21. (canceled)

22. The method according to claim 18,
wherein the identifier contains encrypted data; and
wherein the processor is operable to connect to the communication network to decrypt the encrypted data.

23. The method according to claim 18,
wherein the distributed ledger comprises a plurality of blocks, and each block of the plurality of blocks stores information associated with the identifier allocated to the organism;
wherein the processor is operable to record the additional information in a set of blocks among the plurality of blocks, and each block of the set of blocks stores the information associated with the identifier of the organism.

24. (canceled)

25. The method according to claim 18,
wherein the plurality of computing devices include at least one electronic device operable to monitor the event for the organism and generate the additional information relating to the event;
wherein the electronic device comprises at least one of the following: a sensor, an actuator, a monitor and a camera; and
wherein the electronic device is deployed to monitor the environmental factor of an area where the organism is farmed.

26. (canceled)

27. (canceled)

28. (canceled)

29. The method according to claim 18, wherein the identifier is in a form of at least one of the following: a QR code, barcode, data matrix and maxicode.

30. The method according to claim 29, wherein the identifier is marked on a body of the organism or is attached on the organism using a tag.

31. The method according to claim 29, wherein the identifier further contains a public key of a digital wallet associated with the identifier of the organism, and the processor is operable to record the additional information in the distributed ledger using the digital wallet.

32. The method according to claim 31, wherein the processor is operable to verify an ownership of the organism using a private key stored in the digital wallet.

33. The method according to claim 31, wherein once the organism is consumed, the processor is operable to close the digital wallet.

34. (canceled)
